(19) United States
(12) Patent Application Publication
(10) Pub. No.: US 2011/0005360 A1
(43) Pub. Date: Jan. 13, 2011

(54) ROOT CUTTING TOOL

(75) Inventor: Marcus Gordon BIRCH, London (CA)

Correspondence Address: Eduardo Krupnik, Ontario AgriCentre, 100 Stone Road West, St 301, Canada, ON, N1G 5L3, CA

(73) Assignee: Marcus Gordon Birch, London (CA)

(21) Appl. No.: 12/832,570

(22) Filed: Jul. 8, 2010

Related U.S. Application Data
(60) Provisional application No. 61/223,825, filed on Jul. 8, 2009.

(51) Int. Cl. B26B 1/08

(52) U.S. Cl. 83/13; 30/315

(57) ABSTRACT

The present invention provides for a tool operable to cut objects placed below ground level or on ground level, including tree roots or pipes. The cutting tool of the present invention comprises (a) a base plate, and (b) a cutting plate that includes a cutting. The cutting plate is slidably mounted to the base plate. The cutting edge is capable of moving between a resting position and a cutting position. The cutting edge is configured for cutting an object when positioned in the cutting position.

### CROSS REFERENCE TO RELATED APPLICATIONS

This application claims the benefit of the filing date of U.S. Provisional Application No. 61/223,825, filed Jul. 8, 2009 by the present inventor, the content of which is specifically incorporated herein by reference.

### FIELD OF THE INVENTION

The present invention relates to the general field of cutters, and more particularly to a cutting tool for cutting through objects placed below ground level or on ground level such as roots or the like, and to methods of cutting objects placed below ground level or on ground level.

### BACKGROUND OF THE INVENTION

Shovels commonly found in the market having round points are unable to efficiently cut through plant roots, including tree roots, exceeding about ½″ in diameter. In addition, when the shovels encounter a root in the soil, they tend to rotate laterally, rather than cut through the root, because of their rounded points. Accordingly, when a root exceeding about ½″ in diameter is encountered, an axe is necessary to cut through the root at each side of the hole being dug to remove the root. Since the roots are below ground level, cutting the roots with an axe may take many swings to get through. One can also try using loppers, but the loppers usually end up twisting and require an effort to cut through the root, if at all. One major disadvantage of using an axe and other manually used tools include that the use of manual force may affect the user's lower back. Chain saws are time consuming, dangerous and unwanted soil may stick to the chain of the machine.

Various tools have been developed to cut through roots exceeding ½″ in diameter. However, a major disadvantage of the tools of the prior art is that they require applying manual force to the tool, and they may require using several chopping actions before the root is finally cut through.

U.S. Pat. No. 6,338,511 to Douglas et al. (“Douglas”) discloses a root cutting shovel having a round point type shovel blade which has a straight lower cutting edge and a centrally located root cutting blade projecting along the longitudinal center line of the shovel blade for cutting through tree roots as the shovel blade is forced through root containing soil. The device disclosed by Douglas, however, still requires the user to apply manual force to the shovel blade with the user's feet to drive the shovel into the root being cut.

U.S. Pat. No. 298,926 to Watson (“Watson”) discloses a shovel having a concave cutting edge to cut roots. While Watson's shovel overcomes the disadvantage of the shovel rotating laterally while cutting a root, Watson's shovel still requires applying manual force to the shovel into the root being cut and it may take several chopping actions to cut though the root.

Thus, it is desirable to provide a tool capable of efficiently and effectively cutting objects, including substantially tubular objects such as pipes and roots, and including roots over ½″ in diameter, which does not require using significant manual force and many chopping actions.

### SUMMARY OF THE INVENTION

In one embodiment the present invention provides for a cutting tool comprising: (a) a base plate, and (b) a cutting plate that includes a cutting edge, said cutting plate being slidably mounted to the base plate, and said cutting edge being capable of moving between a resting position and a cutting position, wherein the cutting edge is configured for cutting an object when positioned in the cutting position.

In another embodiment, the present invention provides for a method of cutting an object said method comprising the following steps: (a) providing a cutting tool comprising (i) a base plate, and (ii) a cutting plate that includes a cutting edge, said cutting plate being slidably mounted to the base plate, and said cutting edge being capable of moving between a resting position and a cutting position, wherein the cutting edge is configured for cutting the object when positioned in the cutting position, (b) placing the base plate of the cutting tool on the object to be cut, and (c) moving the cutting edge of the cutting tool from the resting position to the cutting position such that the cutting edge cuts the object.

Advantages of the root cutting tool of present invention include a tool that:

(a) can cut roots or other objects such as pipes over ½″ in diameter;
(b) cut roots or other objects based on leg, rather than manual, force;
(c) cuts roots or other objects without having to chop the root or object several times; and
(d) is capable of keeping the root or other object to be cut from moving such that the tool of the present invention will not slide or rotate while the root or object is being cut.

### BRIEF DESCRIPTION OF THE DRAWINGS

The invention will be better understood when consideration is given to the following detailed description. Such description makes reference to the annexed drawings, wherein:

FIG. 1 illustrates a perspective view of the cutting tool according to one embodiment of the present invention.

FIG. 1A illustrates a perspective view of the cutting tool according to one embodiment of the present invention in the resting position.

FIG. 1B illustrates a perspective view of the cutting tool according to one embodiment of the present invention in the cutting position.

FIG. 2 illustrates a perspective view from the back of the cutting tool according to one embodiment of the present invention.

FIG. 3 illustrates a close-up of the front side view of the cutting tool according to one embodiment of the present invention.

FIG. 3A illustrates a front view of the cutting end of the cutting tool according to one embodiment of the present invention in the resting position.

FIG. 3B illustrates a front view of the cutting end of the cutting tool according to one embodiment of the present invention in the cutting position.

FIG. 4A illustrates the cutting edge of the cutting tool according to one embodiment of the present invention.

FIG. 4B illustrates the cutting edge of the cutting tool according to another embodiment of the present invention.

FIG. 4C illustrates the cutting edge of the cutting tool according to another embodiment of the present invention.

FIG. 4D illustrates the cutting edge of the cutting tool according to another embodiment of the present invention.

FIG. 4E illustrates the cutting edge of the cutting tool according to another embodiment of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENTS

Unless indicated otherwise, except within the claims, the use of “or” includes “and” and vice-versa. Non-limiting terms are not to be construed as limiting unless expressly stated or the context clearly indicates otherwise (for example “including”, “having” and “comprising” typically indicate “including without limitation”). Singular forms included in the claims such as “a”, “an” and “the” include the plural reference unless expressly stated otherwise.

The present invention relates to a tool for cutting objects placed below ground level or on ground level, such as roots, pipes or the like. In one embodiment the present invention relates to a tool that uses the weight of the user for cutting objects placed below ground level or on ground level. In one embodiment, the user uses his or her weight to push a blade down and through the object. One push may be enough to cut through the object.

The cutting tool of the present invention is capable of efficiently and effectively cutting through substantially tubular objects such as pipes and roots, including roots over ½″ in diameter, which does not require using significant manual force and many (usually one) chopping actions.

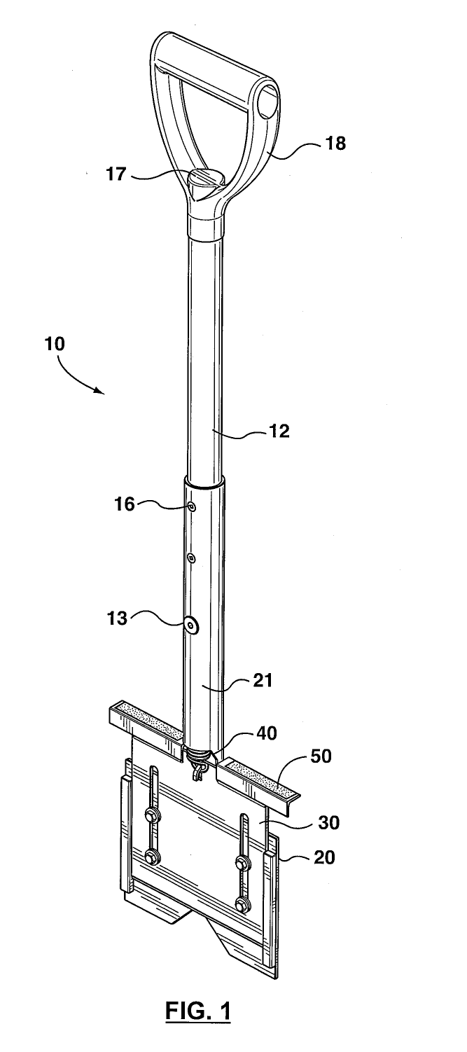

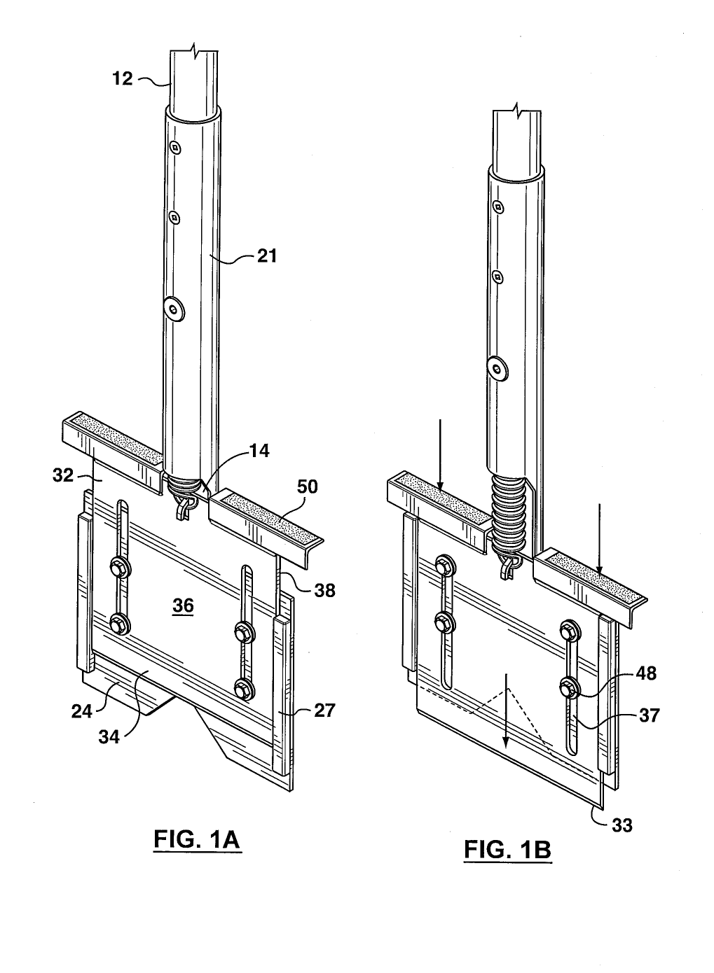

Referring now to FIG. 1 a cutting tool or apparatus 10 is illustrated in accordance with one embodiment of the present invention. The tool 10 is particularly suited and configured to cut objects, particularly substantially tubular objects including pipes and roots over ½″ in diameter that are encountered while digging in soil.

The following discussion and examples concentrate on the application of the present invention in a root cutting scenario, however a person skilled in the art would comprehend these and other alternative implementations of the present invention to cut other objects (i.e. pipes) as a natural extension of the present invention.

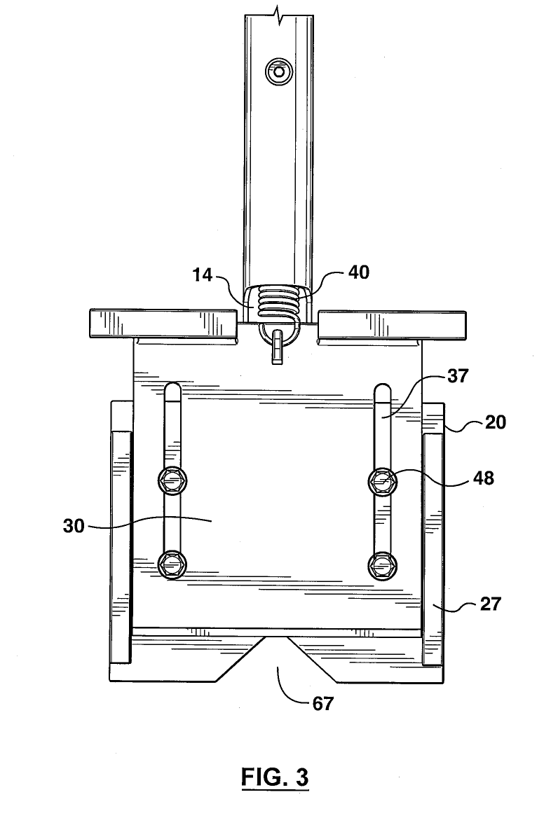

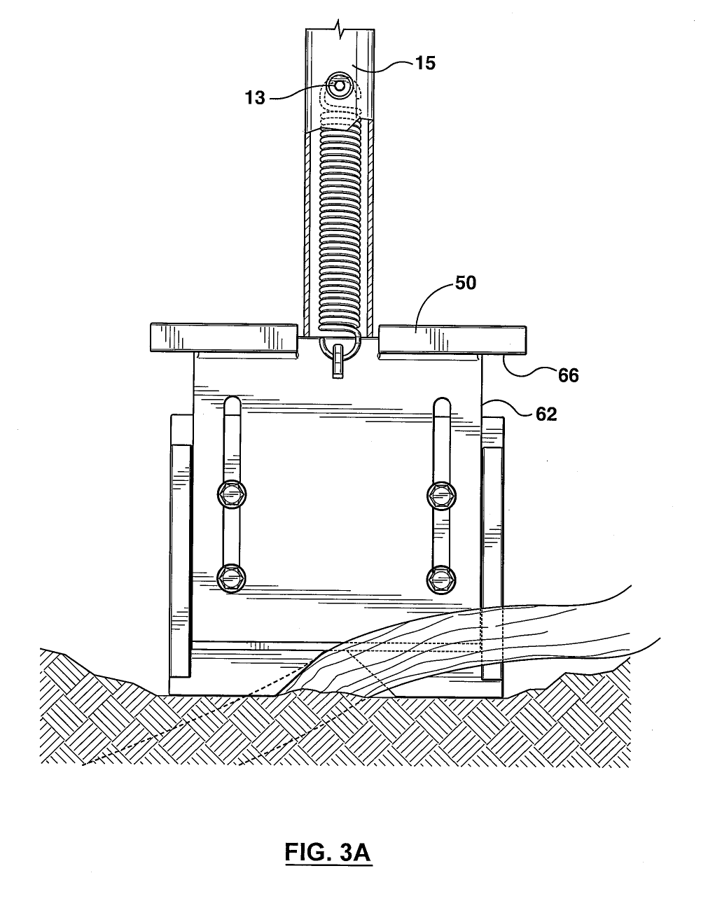

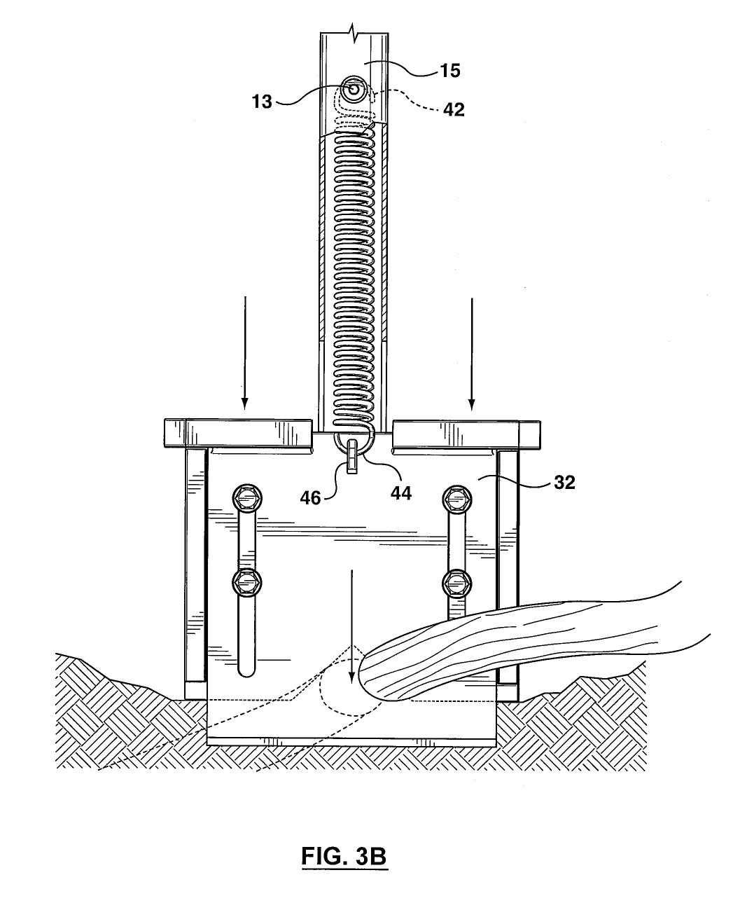

The cutting tool 10 comprises a base plate 20, a cutting plate 30 including a cutting edge 33, wherein said cutting plate 30 is slidably mounted to the base plate 20 and wherein the cutting edge 33 is capable of moving between a resting position as shown in FIG. 1A and FIG. 3A, and a cutting position as shown in FIG. 1B and FIG. 3B. The cutting edge may be configured for cutting an object, like a root, when positioned in the cutting position. Biasing means 40 may be included for biasing the cutting plate 30 to the resting position.

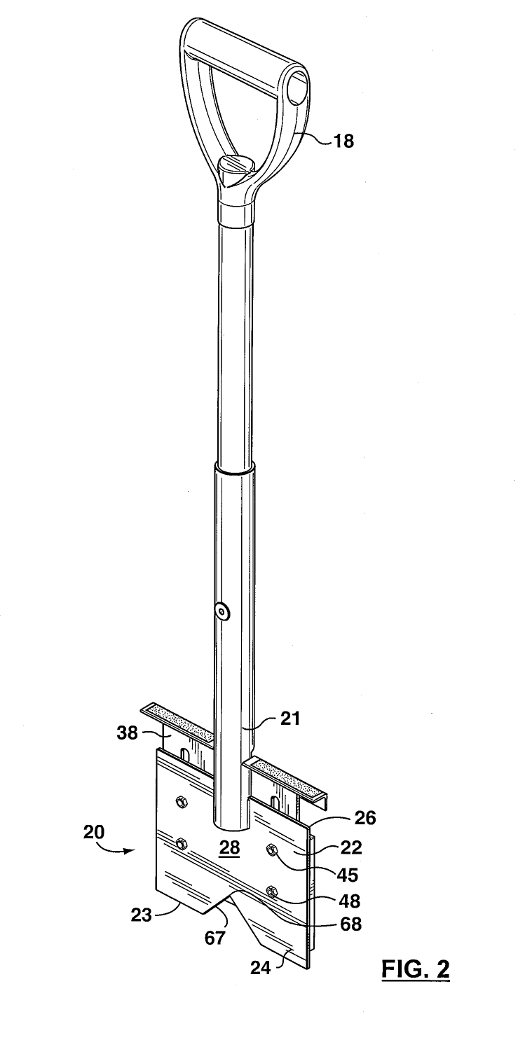

As shown in FIG. 2 the base plate 20 may comprise an upper portion 22, a lower portion 24, a front surface 26 and a back surface 28. A sleeve 21 may extend from the back surface 28, preferably from the upper portion 22. Said sleeve can be adapted to receive and hold a proximal end 15 of a handle means 12. As shown in FIG. 3 the sleeve 21 may include an open end 14. The handle member 12 may take the form of an elongated shaft. The handle member 12 may include a handle 18 coupled to the distal end 17 of the handle member 12. As shown in FIG. 1 the handle member 12 may be attached to the base plate 20 with one or more connecting means 16 such as screws or rivets running though the sleeve 21 and into the shaft of the handle member 12, said connecting means or rivets may be operable to keep the handle member 12 firmly in place. In one embodiment of the present invention the handle member may also be welded to the sleeve. In one embodiment of the present invention the base plate may formed of a single piece and may conveniently combine the base plate and the sleeve into said single piece. In another embodiment of the present invention the base plate, the sleeve and the handle may also be combined into one single piece as this configuration may facilitate the manufacture and use of the present invention.

As shown in FIG. 1, FIG. 1A and FIG. 1B the cutting plate 30 may comprise an upper portion 32, a lower portion 34, a front surface 36 and a back surface 38. To further facilitate the cutting of roots, a foot engaging means 50, such as a step plate, may be attached to the upper portion 32. As shown in FIG. 1B the lower cutting portion may 34 include a cutting edge 33 to facilitate the cutting of roots.

As shown in FIGS. 1A, 1B, 3A, and 3B the cutting plate 30 may be operable to move along the base plate 20 in a vertical manner, whereby it may move upwards and downwards. The cutting plate 30 may be slidably mounted to the base plate 20. The base plate 20 and the cutting plate 30 may be slidably connected with the front surface 26 of the base plate 20 facing the back surface 38 of the cutting plate 30. In one embodiment of the present invention, the base plate and the cutting plate may be connected by a connecting means such as bolting means, rods, rivets or any other connecting means. In this embodiment, the base plate may include one or more holes 45, preferably two or more holes, capable of receiving an elongated connecting means 48 having an elongated free end or shaft such as a bolt or other elongated connecting means. The cutting plate 30 may include one or more elongated slots 37 extending in a direction from the upper portion 32 to the lower cutting portion 34. If one slot is provided, then this one slot may preferably be substantially centrally located within the cutting plate. The one or more elongated slots 37 may be sized and placed to receive the free ends of the elongated connecting means 48 attached to the holes 45 of the base plate 20. The elongated connecting means 48 may be held in place by a locking means, such as locking nuts or any other locking mechanism. The slots 37 and the elongated connecting means 48 may combine to allow sliding movement of the cutting plate 30 and to keep the cutting plate 30 mounted and parallel to the base plate 20. Alternatively, rods may be attached directly to the front surface 26 of the base plate 20 (i.e. no need for holes 45), and the rods may be received by the one or more slots 37 to allow sliding movement of the cutting plate 30 and to keep the cutting plate 30 mounted parallel to the base plate 20. The base plate 20 may include lateral guides 27 on the lateral edges of the base plate 20 capable of slidably receiving the lateral edges 62 of the cutting plate 30. In one embodiment of the present invention, the lateral guides may be formed in an “L” shape to further secure and/or slidably mount the cutting plate to the base plate (not shown). The cutting plate 30 can slide along the guides from the resting position to the cutting position. An embodiment of the present invention that includes a foot engaging means 50 may include extensions 66 that serve to stop the cutting plate 30 at the top end of the guides 27 thereby preventing the cutting plate 30 from travelling a predetermined distance with respect to the low edge 23 of the base plate 20, as shown in FIG. 3A.

As shown in FIG. 1A and in FIG. 3A, the resting position may be a position of the cutting edge 33 while it is not being actuated or operated. In one embodiment of the present invention, the resting position may be achieved when the cutting edge lies at a point above the lower edge 23 of the base plate 20. Alternatively, the resting position may be achieved when the cutting edge is positioned at a point between the upper portion 22 and the lower portion 24 of the base plate 20 at about 2″ from the lower edge 23 or more. The closer the resting position is to the upper portion 22, the more speed that could be generated to the cutting plate 30 as it will travel a longer distance before it hits the target root.

As shown in FIG. 3, FIG. 3A and FIG. 3B, biasing means 40, such as coil springs, may be provided for biasing the cutting plate 30 to the resting position. Biasing means 40 includes an upper end 42 for connection to the handle member 12, preferably to the proximal end 15, and a lower end 44 for connection to cutting plate 30, preferably to the upper portion 32 of the cutting plate 30. For example, in one embodiment of the present invention the upper end of the biasing means may be engaged to an engaging means, such as a rod. The cutting plate 30 may include means for holding the lower end 44 of the biasing means 40, for example, such as a means that may include a rod or a hole or hook 46 adapted for engaging the lower end 44 of the biasing means 40.

The base plate and the cutting plate of the present invention may take any shape and form with the proviso that the cutting plate should be slidable along the base plate from the resting position to the cutting position. As such, in one embodiment of the present invention, the base plate and the cutting plate may be substantially flat. In another embodiment of the present invention, the base plate and the cutting plate may be substantially curved.

To cut an object the cutting edge should be capable of travelling from the resting position to a distance beyond the lower edge of the base plate. The longer the distance the cutting edge travels beyond the lower edge of the base plate, the thicker the diameter of the root that the tool will be able to cut. The cutting position may be achieved if the cutting edge is positioned at a point beyond the lower edge of the base plate. In one embodiment of the present invention, for cutting roots of smaller diameter, the cutting position may be achieved at the lower edge of the base plate.

In an embodiment of the present invention wherein the cutting tool may be provided with holding means (as described below), the cutting edge may be capable of travelling at least to a point between the upper apex or vertex of the holding means and the lower edge of the base plate. In one embodiment of the present invention the cutting edge when positioned in the cutting position may be capable of travelling up to about the lower edge of the base plate. In another embodiment of the present invention, the cutting edge may capable of travelling to a point beyond the lower edge of the base plate.

In yet an embodiment of the present invention to further facilitate the cutting of roots or other objects, the lower portion 24 of the base plate 20 may include a holding means 67, preferably centrally located as shown in FIG. 2 and in FIG. 3. Said holding means may function to substantially keep the root or other object to be cut from rotating, moving or sliding away, as shown in FIG. 3A. A skilled reader in the art will recognize that a variety of shapes or forms of the holding means may be incorporated in embodiments of the present invention. The holding means described herein merely represent possible examples of holding means that may be used and are not to limit the scope of the present invention. In one embodiment of the present invention, the holding means may be formed to incorporate a cavity, bifurcated tip or concave groove. The cavity may take the shape of an inverted “V” groove. In one embodiment of the present invention the holding means may include teeth or other means for grasping to the object to be cut. A holding means may function so as to hold the tool 10 firmly in place when a user steps on the upper end 32 to cut the object.

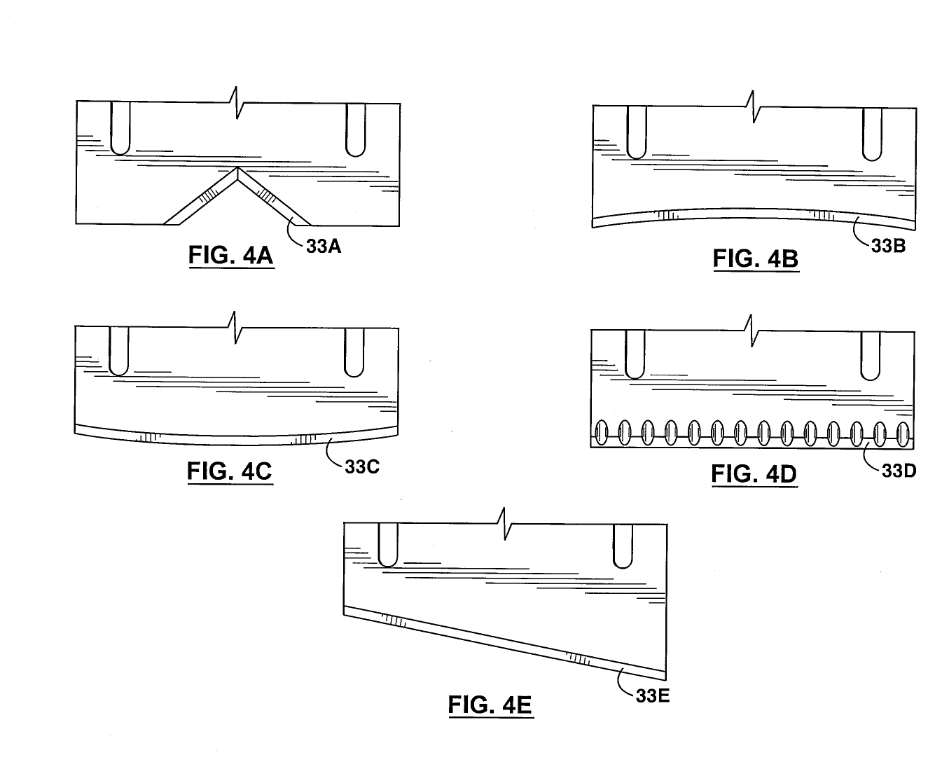

The cutting edge of the cutting plate may include a sharp blade capable of cutting through the object of interest such as, for example, a root. To facilitate the cutting of roots, or other objects of interest, the cutting edge may be provided in various forms. A skilled reader will recognize a variety of cutting edges may be incorporated in embodiments of the present invention. The cutting edges described herein merely represent possible examples of cutting edges that may be used and are not to limit the scope of the present invention. In one embodiment of the present invention, the cutting edge 33a and 33b may include a sharp concave blade, as shown in FIGS. 4A and 4B. The sharp concave blade included in the cutting edge 33a may exist within an inverted “V” cutting cavity as shown in FIG. 4A, or the sharp concave blade included in the cutting edge 33b may extend from one lateral edge of the cutting plate to the other as shown in FIG. 4B. The cutting edge 33c may also take a convex form as shown in FIG. 4C, or the cutting edge 33e may be provided at an angle such as that of a guillotine as shown in FIG. 4E. In another aspect of the invention, the cutting edge 33d may include a plurality of indentations along the side of the blade that can extend along the cutting edge 33d as shown in FIG. 4D.

In an embodiment of the present invention the material that the base plate may be formed of is metal. The sleeve may also be formed of metal, as may be the cutting plate. The metal utilized to form elements of the present invention may be a metal such as hardened steel, and such metal may be forged or stamped. A skilled reader will recognize that elements of the present invention, including the base plate, sleeve and cutting plate, as well as other elements such as the handle, may be otherwise formed from any suitable metal or non-metal material.

An embodiment of the present invention may also provide for methods of cutting an object using the cutting tool of the present invention. The method comprises at least one of the following steps: (a) providing a tool of the present invention; (b) placing the base plate of the cutting tool on the object to be cut; and (b) moving the cutting edge of the cutting tool from the resting position to the cutting position such that the cutting edge cuts the object.

As shown in FIGS. 3A and 3B, while using the tool a user may position the base plate 20 on the root or other object to be cut. If provided with a holding means 67, the root to be cut may be substantially prohibited from moving by the holding means 67 in the base plate 20. The user may then step with one foot or both feet on the edge of upper portion 32 of the cutting plate 30, thereby pushing the lower cutting portion 34 (in the direction of the arrows as shown in FIG. 3B) with the sharp cutting edge 33 towards and through the root, thereby cutting the root. The user may then steps off of the tool 10 and the cutting plate 30 may return to its original resting position.

Accordingly, the reader will see that the cutting tool of the present invention can be used to effectively and conveniently cut objects placed below ground level or on ground level such as roots. In addition the tool of the present invention allows a user to use just his/her weight for cutting objects placed below ground level or on ground level. One push of the cutting plate of the tool of the present invention may be enough to cut through the object.

It will be appreciated by those skilled in the art that other variations of the embodiments described herein may also be practiced without departing form the scope of the invention. Other modifications are therefore possible.

I claim:

1. A cutting tool comprising:
(a) a base plate, and
(b) a cutting plate that includes a cutting edge, said cutting plate being slidably mounted to the base plate, and said cutting edge being capable of moving between a resting position and a cutting position, wherein the cutting edge is configured for cutting an object when positioned in the cutting position.

2. The cutting tool of claim 1, wherein said cutting tool incorporates a biasing means for biasing the cutting edge to the resting position.

3. The cutting tool of claim 1, wherein a handle means is attached to the base plate.

4. The cutting tool of claim 3, wherein said cutting tool incorporates a biasing means for biasing the cutting edge to the resting position, and said biasing means is attached at one end to the cutting plate and at another end to the handle means.

5. The cutting tool of claim 1, wherein said base plate includes a holding means configured for substantially keeping an object to be cut by said cutting tool from moving or sliding away.

6. The cutting tool of claim 5, wherein said holding means comprises a cavity in said base plate.

7. The cutting tool of claim 1, wherein said cutting plate includes one or more slot means capable of receiving corresponding elongated means extending from the base plate, and wherein the elongated means and slot means combine to slidably mount the cutting plate to the base plate.

8. The cutting tool of claim 1, wherein said base plate includes guiding means capable of slidably receiving the cutting plate.

9. The cutting tool of claim 1, wherein said base plate includes guiding means capable of slidably mounting the cutting plate to the base plate.

10. The cutting tool of claim 1, wherein said base plate includes foot engaging means.

11. The cutting tool of claim 1, wherein the cutting edge includes a concave blade.

12. The cutting tool of claim 1, wherein the cutting edge includes a convex blade.

13. The cutting tool of claim 1, wherein the cutting tool is capable of cutting an object placed below ground level.

14. A method of cutting an object said method comprising the following steps:
(a) providing a cutting tool comprising (i) a base plate, and (ii) a cutting plate that includes a cutting edge, said cutting plate being slidably mounted to the base plate, and said cutting edge being capable of moving between a resting position and a cutting position, wherein the cutting edge is configured for cutting the object when positioned in the cutting position,
(b) placing the base plate of the cutting tool on the object to be cut, and
(c) moving the cutting edge of the cutting tool from the resting position to the cutting position such that the cutting edge cuts the object.

15. The method of claim 14, wherein said cutting tool incorporates biasing means for biasing the cutting edge to the resting position, and wherein said method further comprises (c) the cutting edge returning to the resting position.

16. The method of claim 14, wherein in said resting position the cutting edge lies at a point above a lower edge of the base plate.

17. The method of claim 14, wherein in said cutting position the cutting edge lies at a point beyond a lower edge of the base plate.

18. The method of claim 14, wherein said object is placed below ground level.

19. The method of claim 14, wherein said cutting edge is moved from the resting position to the cutting position using a weight of a user.

20. The method of claim 14, wherein said cutting tool further comprises a foot engaging means to move the cutting edge from the resting position to the cutting position.
